(19) United States
(12) Patent Application Publication
(10) Pub. No.: US 2004/0017805 A1
(43) Pub. Date: Jan. 29, 2004

(54) Intelligent cross connect

(76) Inventors: Robert B. Smith, Loveland, CO (US); Gary E. Long, Loveland, CO (US)

Correspondence Address: THE LAW OFFICES OF WILLIAM W. COCHRAN, LLC, 3555 STANFORD ROAD, SUITE 230, FORT COLLINS, CO, 80525, US

(21) Appl. No.: 10/205,678

(22) Filed: Jul. 25, 2002

(51) Int. Cl. H04L 12/50

(52) U.S. Cl. 370/386

(57) ABSTRACT

Disclosed is a switching array for the switching of electrical signals from any input to any output. Large arrays are built upon a recursive use of small arrays that are connected such that several paths are available for the routing of each signal. The resultant arrays may be fault tolerant in that the failure of a single switch does not impede the ability for the system to make connections from one point to another.

### BACKGROUND OF THE INVENTION

a. Field of the Invention

The present invention pertains generally to interconnect systems and specifically to switches that allow interconnects between large numbers of inputs and outputs.

b. Description of the Background

The need for analog or digital multiplexers or switching networks is well established. A common example is in telephony where large numbers of inputs need to be switched to large numbers of outputs, with each input needing to be mapped or routed to a specific output. Switching networks are commonly placed at the telephone company's central office as an automated distribution frame, in the outside plant world as an automated service area interface, within a high rise building with a direct feed from the central office, or in other places within the telephone network. Switching networks are also commonly used in PBX systems and other telephone networks.

In addition to telephony, switching networks may be used for test and measurement applications, computer network cross connections, and other communication networks.

In order to provide connectivity from any point to any point in a matrix, a fully populated array of switches offers a simple solution. For example a matrix with 32 inputs and 32 outputs would require 1024 switches, one at each potential cross connect. There are several problems with this solution. Each input line is connected to 32 switches, and each switch adds capacitance to the line and thereby degrades the signal carried on the line. Further, as multiple failures of the switches occur, either shorts or opens, the switching matrix quickly becomes non-functional. The number of switches, and thus the cost of the matrix, increases by the square of the number of inputs and outputs, using the fully populated matrix.

Some of the problems with full matrices are the large amount of switches required to fully populate the matrix compared with the actual number of switches necessary to complete every circuit. In the above example, of the 1024 switches in a 32×32 array, only 32 switches would be activated to route every 32 input to an output. In a fully populated matrix, a single shorted switch will permanently connect a particular input to a particular output, with no way to disconnect that circuit. The remaining inputs and outputs would still be usable, but that particular input and output would not be usable.

It would therefore be advantageous to provide a switching matrix that has the ability to switch large numbers of inputs and outputs without the cost associated with a fully populated array. In would be further advantageous to provide a switching matrix that has some degree of fault tolerance, so that open or shorted switches may be avoided.

### SUMMARY OF THE INVENTION

The present invention overcomes the disadvantages and limitations of the prior art by providing a sparsely populated array for the switching of any input to any output. It would be further advantageous if the array was redundant such that the failure of one or more switches in the array may be avoided while still allowing connections to be made. It would further be advantageous to provide a switch circuit that has very minimal current drain and can be refreshed on a periodic basis.

The present invention may therefore comprise a switch matrix comprising: a first support column of a plurality of input support arrays, an input support array being a matrix of switches with a number of inputs and a number of outputs wherein any input may be connected to any output; a second support column of a plurality of output support arrays, an output support array being a matrix of switches with a number of inputs and a number of outputs wherein any input may be connected to any output, said second support column having an equal number of support arrays as said first support column, and said number of outputs of said input support arrays being equal to said number of inputs of said output support arrays, and said number of inputs of said input support arrays being equal to said number of outputs of said output support arrays; a core column of a plurality of core arrays, said core arrays being a matrix of switches with a number of inputs and a number of outputs wherein any input may be connected to any output, the number of said core arrays being equal to the number of outputs of said input support arrays and the number of said input support arrays being equal to the number of inputs of said core arrays; and wherein each input support array has an output connected to a different core array.

The present invention may further comprise a refreshable latching switch with low current drain comprising: a switchable signal line having an input and an output; a control line having an input; a first MOSFET and a second MOSFET wherein the source of said first MOSFET and the source of said second MOSFET are connected, and said input of said switchable signal line is connected to the drain of said first MOSFET and said output of said switchable signal line is connected to the drain of said second MOSFET, and the gate of said first MOSFET is connected to said control line and the gate of said second MOSFET is connected to said control line; a capacitor connected from said gate of said first MOSFET to said source of said first MOSFET, said capacitor being adapted to hold said first MOSFET and said second MOSFET in an open or closed state; and a resistor connected to said gate of said first MOSFET and said input of said control line.

The present invention may further comprise a dual pole refreshable switch with low current drain comprising: a first switchable signal line having an input and an output; a second switchable signal line having an input and an output; a control line having an input; a first MOSFET and a second MOSFET wherein the source of said first MOSFET and the source of said second MOSFET are connected, and said input of said first switchable signal line is connected to the drain of said first MOSFET and said output of said first switchable signal line is connected to the drain of said second MOSFET, and the gate of said first MOSFET is connected to said control line and the gate of said second MOSFET is connected to said control line; a first capacitor connected from said gate of said first MOSFET to said source of said first MOSFET, said capacitor being adapted to hold said first MOSFET and said second MOSFET in an open or closed state; a first resistor connected to said gate of said first MOSFET and said input of said control line; a third MOSFET and a fourth MOSFET wherein the source of said third MOSFET and the source of said fourth MOSFET are connected, and said input of said second switchable signal line is connected to the drain of said third MOSFET and said output of said second switchable signal line is connected to the drain of said fourth MOSFET, and the gate of said third MOSFET is connected to said control line and the gate of said third MOSFET is connected to said control line; a second capacitor connected from said gate of said third MOSFET to said source of said third MOSFET, said capacitor being adapted to hold said third MOSFET and said fourth MOSFET in an open or closed state; and a second resistor connected to said gate of said third MOSFET and said input of said control line.

The advantages of the present invention are that any input may be connected to any output with a degree of redundancy. Several connection paths are available such that a failure in one or more switches may be avoided while still being able to make every connection without the cost and performance drains of a fully populated array.

### BRIEF DESCRIPTION OF THE DRAWINGS

In the drawings,

FIG. 1 is an illustration of an embodiment of the present invention of a 32×32 switch network.

FIG. 2 is an illustration of an embodiment of the present invention of a 128×128 switch array.

FIG. 3 is a schematic diagram of an embodiment of the present invention of a switch circuit.

FIG. 4 is an illustration of an embodiment of an addressing scheme for the 32×32 array of the embodiment of the present invention illustrated in FIG. 1.

FIG. 5 is an illustration of an embodiment of the present invention wherein the switch circuit is built into a portion of a switch array.

FIG. 6 is an illustration of an embodiment of the column switch driver that may be used in the embodiment of FIG. 5.

FIG. 7 is an illustration of an embodiment of the row switch driver that may be used in the embodiment of FIG. 5.

FIG. 8 is an illustration of an embodiment of a 512×512 configuration of the present invention wherein four columns of support muxes are used with a column of 32×32 core muxes.

FIG. 9 is an illustration of an embodiment of the present invention of a 512×512 switch array.

FIG. 10 is an illustration of an embodiment of the present invention wherein a 500×500 switch matrix is comprised of several layers of support muxes.

### DETAILED DESCRIPTION OF THE INVENTION

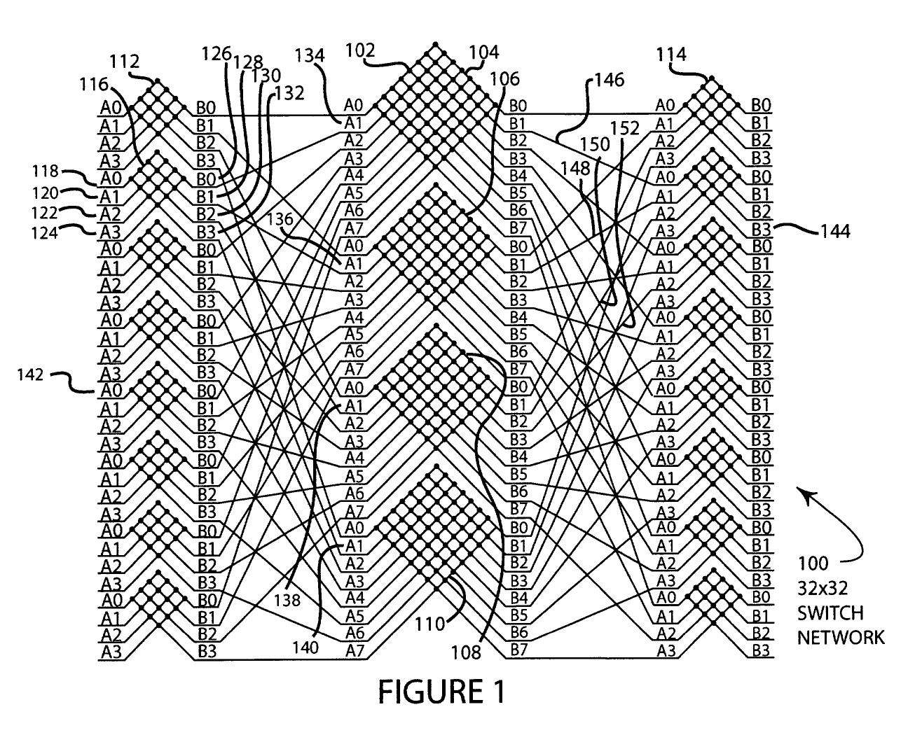

FIG. 1 illustrates an embodiment 100 of the present invention of a 32×32 switch network. Each dot 102 represents a switch between two signal lines. The switch 102 may be open or closed. The embodiment 100 comprises 512 switches arrayed in several cells. The center cells 104, 106, 108, and 110 are 8×8 arrays, each having 64 switches. Two outside columns 112 and 114 each comprise quantity 8, 4×4 arrays. The 4×4 array 116 has inputs 118, 120, 122, and 124. The outputs of the array 116 are lines 126, 128, 130, and 132. The outputs of array 116 are connected to the inputs 134, 136, 138, and 140 of the center cells 104, 106, 108, and 110. The outside column 114 has arrays similarly connected.

Embodiment 100 represents a switch for a 32×32 network. For a fully populated 32×32 matrix, 1024 switches would be required. Embodiment 100 represents exactly half of the number of switches required for a fully populated array. In addition, for a fully populated array, each completed circuit would have the capacitance effects of 63 switches attached to the circuit. With the present embodiment 100, each path crosses 29 switches.

Embodiment 100 provides four alternative routes for completing each circuit. This feature allows problem switches, either permanently open or closed switches, to be bypassed and still allow all of the circuits to be completed. For example, the path from input 142 to output 144 may follow any of the paths 146, 148, 150, or 152 to be completed. If a particular switch in one of the paths was known bad, one of the alternative paths may be selected.

The paths 146, 148, 150, and 152 are the simplest paths available to complete the circuit. The paths were selected to illustrate that alternative paths are available using the least number of interconnects. Other paths may be selected that use more switches without violating the spirit or intent of the present invention.

With the present embodiment 100, no single switch in the array is critical for a circuit to be completed. In other words, for each input and output, there is no point where a failure of a single switch would prohibit a circuit to be completed. Further, the embodiment 100 is a non-blocking switch, wherein the connection of one or more circuits does not block or prohibit another circuit from being connected.

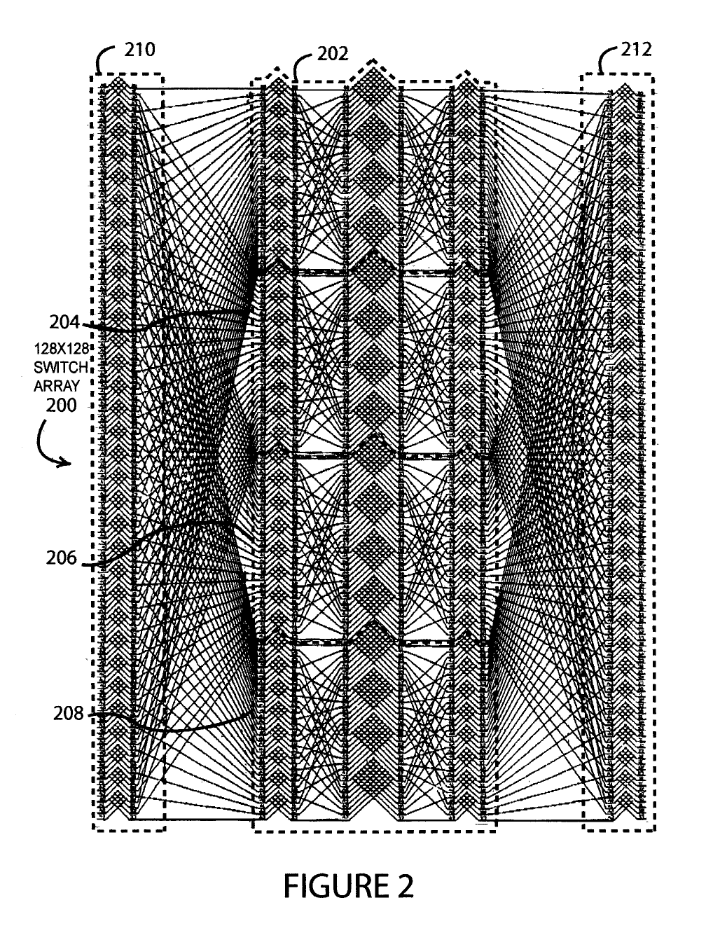

FIG. 2 illustrates an embodiment 200 of the present invention of a 128×128 switch array. The block 202 represents a 32×32 switch array of embodiment 100. Four 32×32 blocks 202, 204, 206, and 208 populate the center three columns of arrays. The outside columns 210 and 212 contain 4×4 switch arrays, with each 4×4 array connected to each of the four 32×32 arrays.

The functionality and benefits of the 32×32 switch array of embodiment 100 are similar to the 128×128 switch array of embodiment 200. A fully populated matrix of 128×128 switches would comprise 16,384 switches. The present embodiment 200 comprises 2304 switches. In a fully populated array, each circuit would have the capacitance effects of 255 switches, whereas the present embodiment 200 has the effect of 43 switches. For a given input and output of the present embodiment 200, there are 16 unique pathways using the minimum number of switches.

The 32×32 arrays 202, 204, 206, and 208 may be termed a core mux. The columns 210 and 212 may be termed a support mux. The embodiment 200 comprises a core mux with two support muxes.

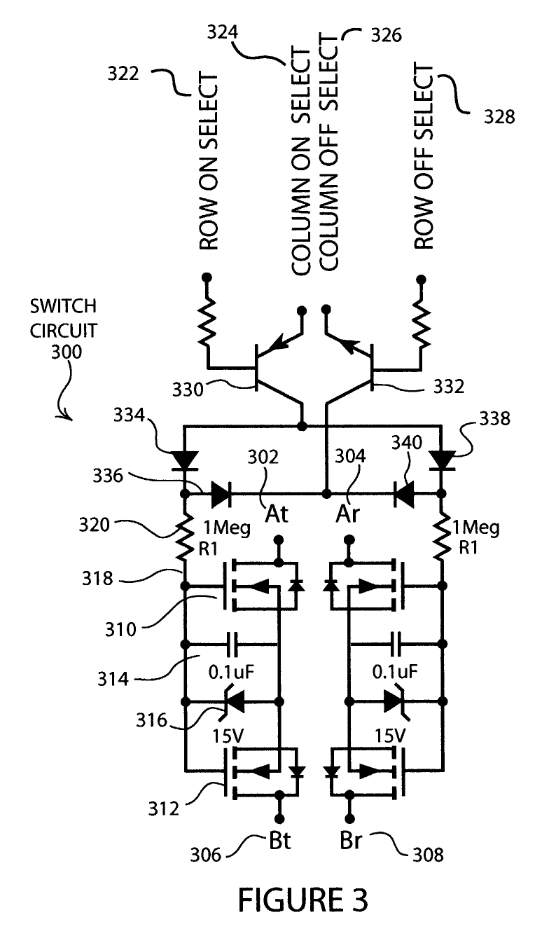

FIG. 3 illustrates a schematic diagram of a switch circuit 300 for a typical application of the present invention. In a telephony applications, each switch actually switches two circuits: the tip and ring connections. The circuit 300 represents a mechanism for switching both tip and ring in parallel that has a latching feature. The input lines to be switched are labeled At 302 and Ar 304, and the output lines labeled Bt 306 and Br 308. The switching circuit comprises two FETs 310 and 312 with the sources tied together. The inherent capacitance between the gate and source of the FET is enhanced with a capacitor 314. A zener diode 316 regulates the voltage across the FET gate. When a voltage is applied to the control line 318, the charge across the gate is held for a period of time, even when the charge is removed, and the switch remains closed. When the control voltage is drained, the switch opens and remains open for a period of time, regardless of any voltage on the input or output lines. The resistor 320 effectively isolates the switching circuit from the control circuitry.

The latching action of the switch circuit allows the switch to be refreshed periodically without having to maintain a constant control line voltage. This functionality allows a simple scanning refresh to keep an array made of switch circuit 300 in a certain set of states. The low amount of power draw for refresh makes the power consumption of many devices very manageable.

The control of the switch is handled by four control lines: row on select 322, column on select 324, column off select 326, and row off select 328. Row on select 322 is connected to the base of the PNP transistor 330, column on select 324 is connected to the emitter of the transistor 330, and the collector drives the switch circuit. To turn on the cell or cross point, a voltage is applied to the row on select 322 and the column on select 324 lines, the control line 318 and the switch is turned on. The switch is held on with the capacitor 314 when either or both of the row on select 322 or column on select 324 are brought low. In the same manner, column off select 326 and row off select 328 are connected to an NPN transistor 332. When the column off select 326 and row off select 328 are brought low, the control line 318 is brought low, draining the capacitor 314, and opening the switch circuit. The diodes 334, 336, 338, and 340 are steering diodes, ensuring that the on and off control circuits do not interfere with each other.

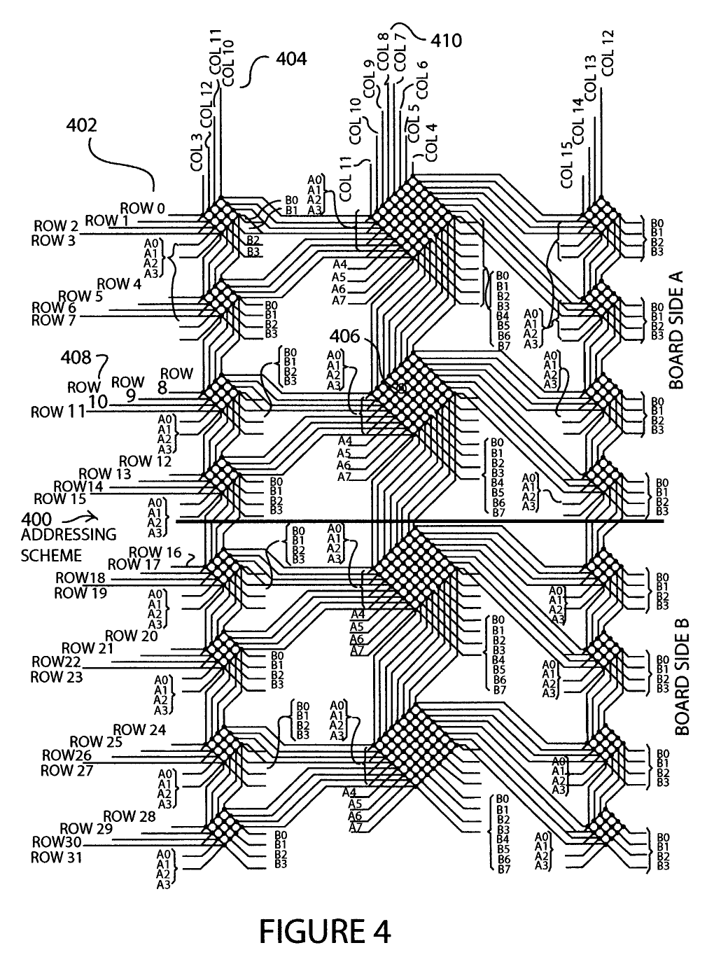

FIG. 4 illustrates an embodiment 400 of an addressing scheme for the 32×32 array of embodiment 100 illustrated in FIG. 1. In the present figure, the switch arrays are shown but the signal pathway interconnects between the arrays are not shown for clarity. In the present addressing scheme, each switch can be identified by a row and column address. The row addresses 402 are shown on the left hand side of the illustration and the column addresses 404 are shown on the top of the illustration. The row address lines connect the switches across the horizontal direction and the column address lines connect the switches down the vertical direction. For example, switch 406 may be addressed through signal lines 408 and 410.

The addressing scheme of embodiment 400 allows each switch to be individually turned on and off by scanning through the rows and columns and thereby individually turning on and off each switch.

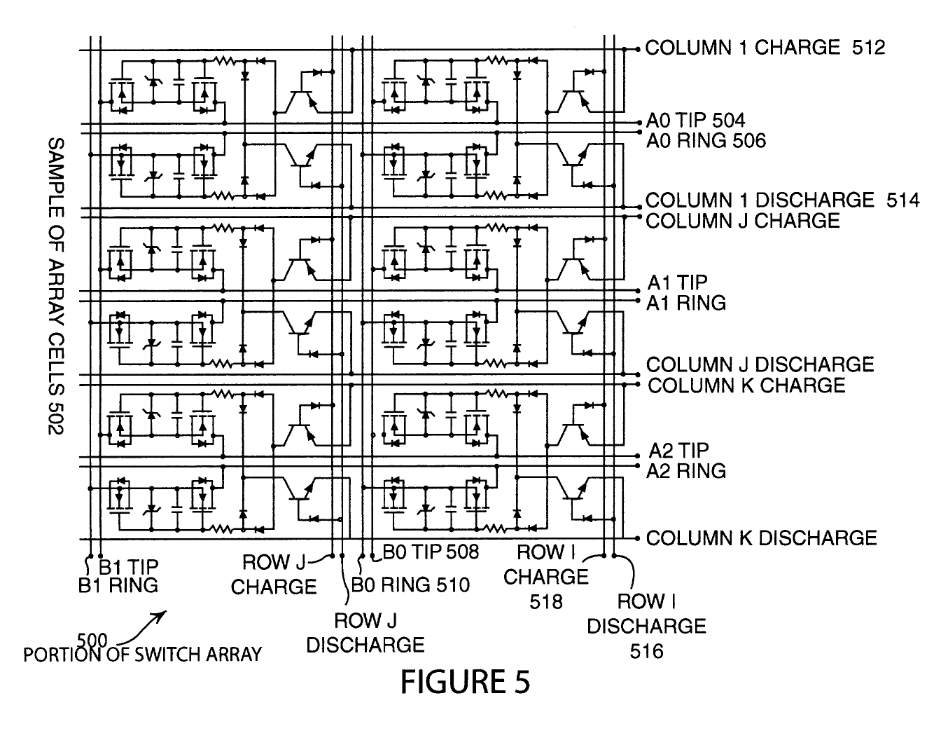

FIG. 5 illustrates an embodiment 500 of the present invention wherein the switch circuit of embodiment 300 is built into a portion of a switch array 502. The array 502 represents the first three rows and first two columns of a typical array in the embodiment 400 of FIG. 4. The A0 Tip 504 and A0 Ring 506 input lines are connected to each row of the array 502, and the B0 Tip 508 and B0 Ring 510 output lines are connected to each column of the array 502. The Column I Charge 512 and Column I Discharge 514 are connected across all of the switches in the left hand column, as Row I Discharge 516 and Row I Charge 518 are connected across the top row.

In other embodiments, solid state relays, latching relays, mercury wetted relays, or other forms of electrical switches may be implemented by those skilled in the arts while still maintaining within the scope and intent of the present invention.

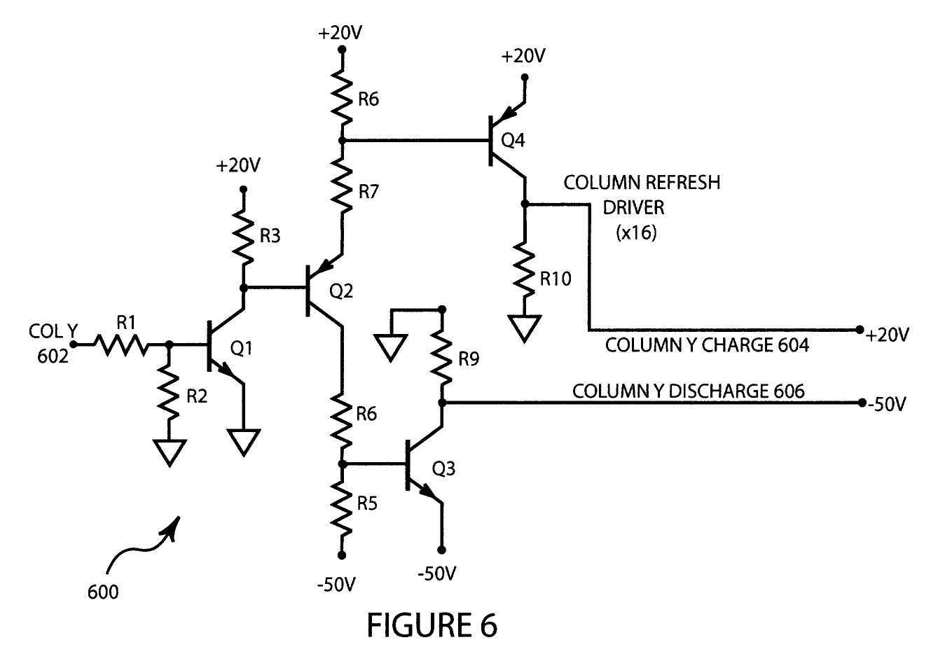

FIG. 6 illustrates an embodiment 600 of the column switch driver that is connected to the Column I Charge 512 and Column I Discharge 514 signals of embodiment 500. When the ColY 602 line is turned on, the Column Y Charge 604 is switched to +20V and the Column Y Discharge 606 is switched to −50V. The embodiment 600 is replicated for each column.

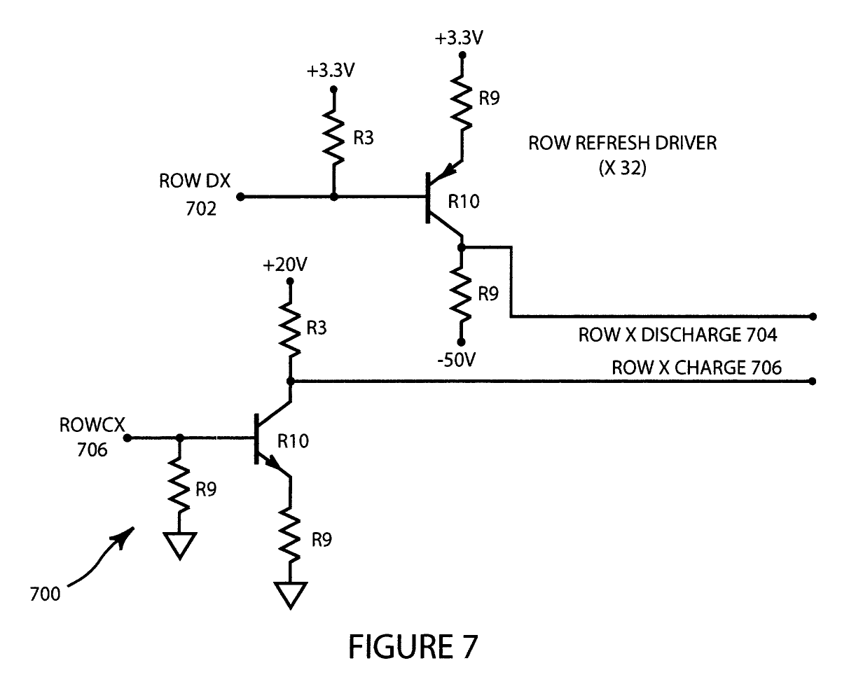

FIG. 7 illustrates an embodiment 700 of the row switch driver circuits that are connected to the Row I Charge 518 and Row I Discharge 516. The RowDX 702 line is the input signal to discharge the particular row, and switches the Row X Discharge 704 line from −50V to +3.3V. The RowCX 706 line is the input signal to charge the particular row, and switches the Row X Charge 708 line from +20V to ground.

When the column switch driver circuit 600 and row switch driver circuits 700 are combined with the array 500, the array may be controlled by scanning through each column. When a column is to be refreshed, the particular column driver is turned on, applying +20V to the column charge line and −50V to the column discharge line. For each individual row, either the row charge or discharge lines are selected. The selection of a row charge or discharge line forces the switch cells to the open or closed status. If the cell is already in the particular state, the capacitance in the switch circuit is refreshed so that the switch will stay in the particular state. In this manner, each column may be refreshed simultaneously. As each column is scanned in order, the array stays refreshed and any changes to the status, such as opening or closing a cell or group of cells may be performed.

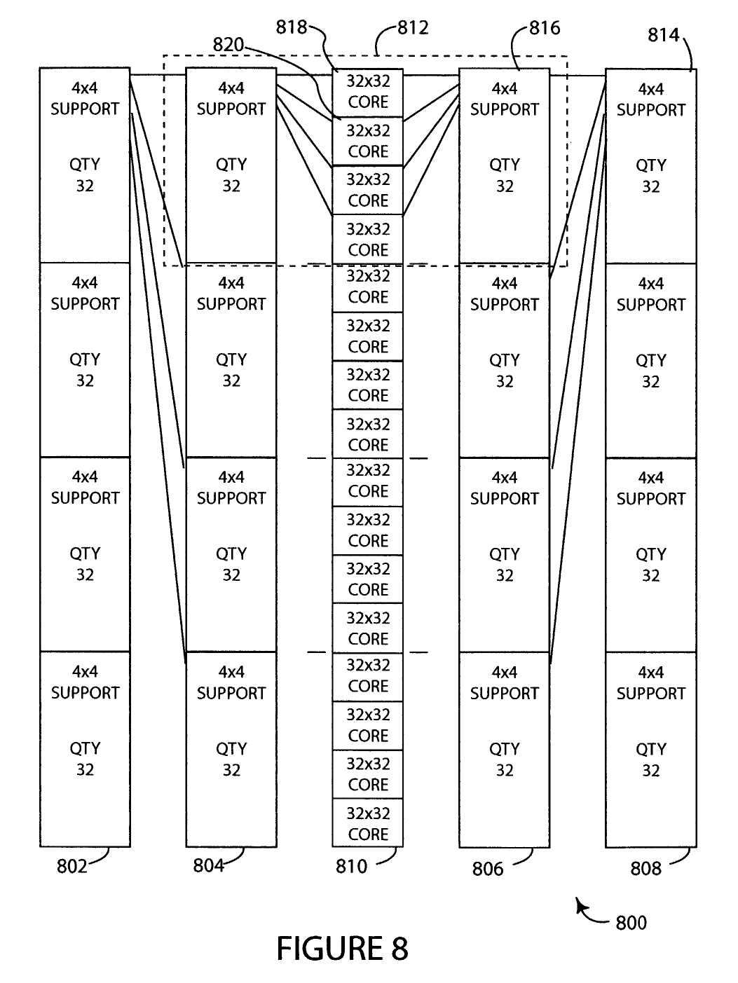

FIG. 8 illustrates an embodiment 800 of a 512×512 configuration of the present invention wherein four columns of support muxes 802, 804, 806, and 808 are used with a column of 32×32 core muxes 810. The column of core muxes 810 is comprised of quantity 16 of 32×32 arrays such as the embodiment 100 of FIG. 1. The group 812 of core muxes and support muxes is the embodiment 200 of FIG. 2, a 128×128 array.

The 4×4 support mux block 814 contains quantity 32 of the 4×4 switch arrays as discussed in FIG. 2 as column 210. Such a block may be configured into one printed circuit card and may contain a total of 512 switches. The printed circuit card may be connected to a backplane to assemble the embodiment 800 of a complete switch array. Further, the same printed circuit card may be used for the outermost support mux 814 as for the inner support 816. Core muxes 818 and 820 may be likewise configured onto a printed circuit board having a total of 1024 switches.

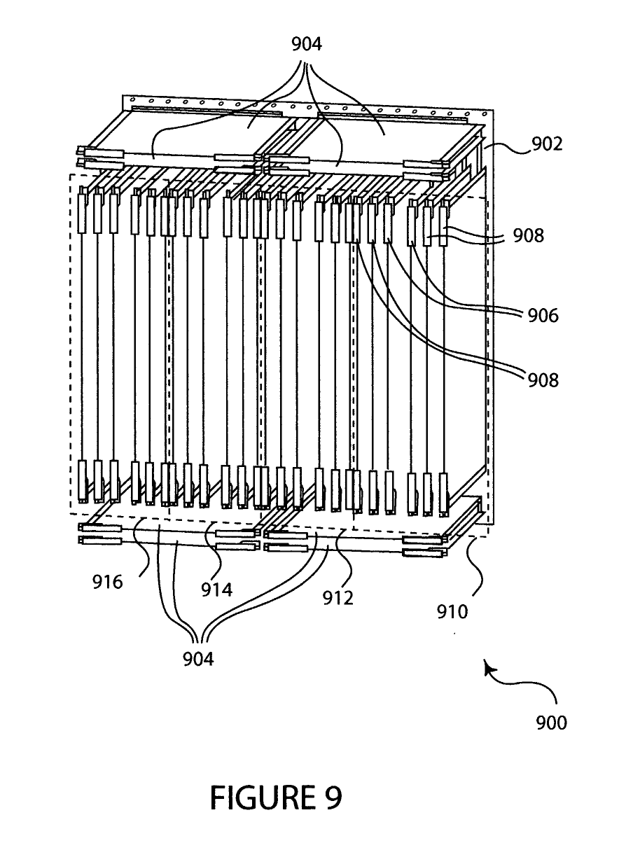

FIG. 9 illustrates an embodiment 900 of the present invention of a 512×512 switch array. The backplane 902 connects all of the component cards. Controller and auxiliary cards 904 may handle the communication and control functions of the switch array. Support mux cards 908 may each contain 512 sets of switches as described in FIG. 8 as block 814. Core mux cards 906 may contain 1024 sets of switches as described in FIG. 8 as blocks 818 and 820.

The group of cards 910 contain two outer support muxes, two additional outer support muxes, and two center mux cards. The group 910 represents one fourth of a 512×512 switch array. The remaining groups 912, 914, and 916 complete the array.

The controller and auxiliary cards 904 may receive commands from another device indicating the connections that are required, may perform self test diagnostics, and other functions as may be required. The embodiment 900 may require an enclosure, power supplies, and other support hardware that is not shown.

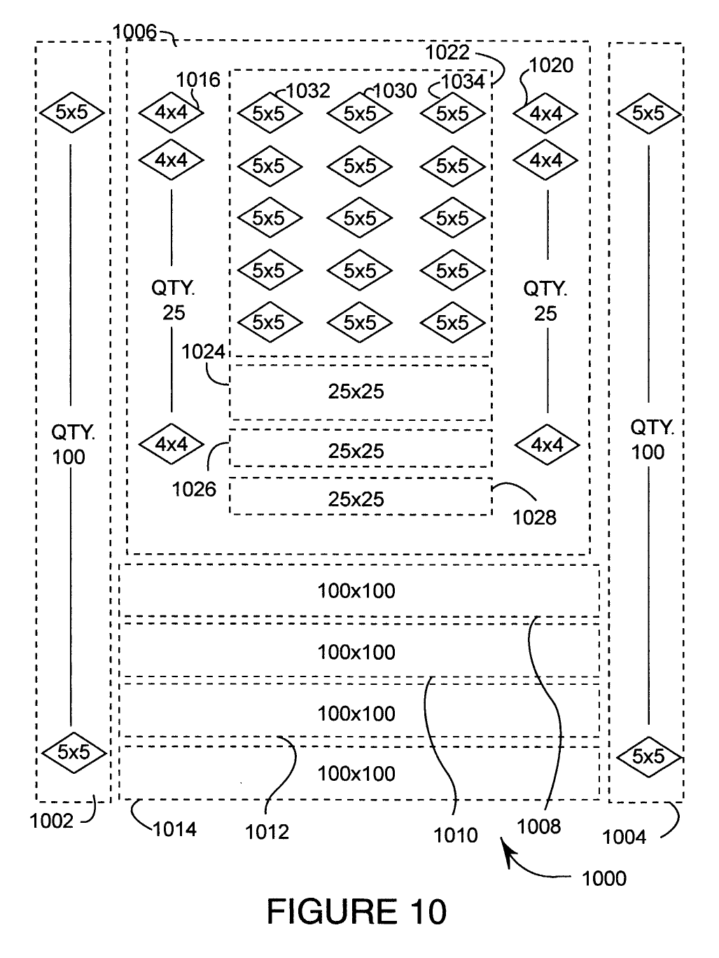

FIG. 10 illustrates an embodiment 1000 of the present invention wherein a 500×500 switch matrix is comprised of several layers of support muxes. The outermost columns 1002 and 1004 of support muxes are a quantity 100 of 5×5 arrays. The outermost columns 1002 and 1004 are connected to quantity 5 100×100 arrays 1006, 1008, 1010, 1012, and 1014. The 100×100 array 1006 is composed of two columns 1016 and 1018 of quantity 25 4×4 arrays and quantity four 25×25 arrays 1022, 1024, 1026, and 1028. The 25×25 array 1022 is composed of quantity 15 5×5 arrays arranged in a center column 1030 and two support columns 1032 and 1034.

The embodiment 1000 illustrates that the individual arrays may be of any size. Further, the arrays may be configured in various recursive layers to meet almost any size of large switch matrix. The most efficient configurations may be for each individual array to be square, in other words with the same number of inputs and outputs. Rectangular arrays may be used if additional redundancy is desired.

For each output of an outer support mux array, there may be one replication of the next inner mux layer. In the present embodiment 1000, the 5×5 arrays of the outer columns 1002 and 1004 connect to five replications of the 100×100 arrays of the next level. Similarly, the 4×4 arrays of columns 1016 and 1018 connect to four replications of the 25×25 arrays 1022, 1024, 1026 and 1028. Using various sizes of smaller arrays, larger switching arrays may be similarly constructed.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A switch matrix comprising:
a first support column of a plurality of input support arrays, an input support array being a matrix of switches with a number of inputs and a number of outputs wherein any input may be connected to any output;
a second support column of a plurality of output support arrays, an output support array being a matrix of switches with a number of inputs and a number of outputs wherein any input may be connected to any output, said second support column having an equal number of support arrays as said first support column, and said number of outputs of said input support arrays being equal to said number of inputs of said output support arrays, and said number of inputs of said input support arrays being equal to said number of outputs of said output support arrays;
a core column of a plurality of core arrays, said core arrays being a matrix of switches with a number of inputs and a number of outputs wherein any input may be connected to any output, the number of said core arrays being equal to the number of outputs of said input support arrays and the number of said input support arrays being equal to the number of inputs of said core arrays; and
wherein each input support array has an output connected to a different core array.

2. The switch matrix of claim 1 wherein said number of inputs of said input support arrays is equal to said number of outputs of said input support arrays.

3. The switch matrix of claim 1 further comprising:
said core arrays further comprising a first core support column of a plurality of input core support arrays, an input core support array being a matrix of switches with a number of inputs and a number of outputs wherein any input may be connected to any output, a second core support column of a plurality of output core support arrays, an output core support array being a matrix of switches with a number of inputs and a number of outputs wherein any input may be connected to any output, said second core support column having an equal number of core support arrays as said first core support column, and said number of outputs of said input core support arrays being equal to said number of inputs of said output core support arrays, and said number of inputs of said input core support arrays being equal to said number of outputs of said output core support arrays, a center core column of a plurality of center core arrays, said center core arrays being a matrix of switches with a number of inputs and a number of outputs wherein any input may be connected to any output, the number of said center core arrays being equal to the number of outputs of said input core support arrays and the number of said input core support arrays being equal to the number of inputs of said center core arrays, wherein each input core support array has an output connected to a different center core array.

4. The switch matrix of claim 3 further comprising:
said center core arrays further comprising a first center core support column of a plurality of input center core support arrays, an input center core support array being a matrix of switches with a number of inputs and a number of outputs wherein any input may be connected to any output, a second center core support column of a plurality of output center core support arrays, an output center core support array being a matrix of switches with a number of inputs and a number of outputs wherein any input may be connected to any output, said second center core support column having an equal number of center core support arrays as said first center core support column, and said number of outputs of said input center core support arrays being equal to said number of inputs of said output center core support arrays, and said number of inputs of said input center core support arrays being equal to said number of outputs of said output center core support arrays, a kernel center core column of a plurality of kernel center core arrays, said kernel center core arrays being a matrix of switches with a number of inputs and a number of outputs wherein any input may be connected to any output, the number of said kernel center core arrays being equal to the number of outputs of said input center core support arrays and the number of said input center core support arrays being equal to the number of inputs of said kernel center core arrays, wherein each input core support array has an output connected to a different kernel center core array.

5. The switch matrix of claim 4 further comprising:
said number of kernel center core array inputs being equal to said number of kernel center core array outputs;
said number of center core support array inputs being equal to said number of center core support array outputs;
said number of core support array inputs being equal to said number of core support array outputs; and
said number of support array inputs being equal to said number of support array outputs.

6. The switch matrix of claim 5 further comprising:
said number of kernel center core array inputs being eight;
said number of center core support array inputs being four;
said number of core support array inputs being four; and
said number of support array inputs being four.

7. A refreshable latching switch with low current drain comprising:
a switchable signal line having an input and an output;
a control line having an input;
a first MOSFET and a second MOSFET wherein the source of said first MOSFET and the source of said second MOSFET are connected, and said input of said switchable signal line is connected to the drain of said first MOSFET and said output of said switchable signal line is connected to the drain of said second MOSFET, and the gate of said first MOSFET is connected to said control line and the gate of said second MOSFET is connected to said control line;
a capacitor connected from said gate of said first MOSFET to said source of said first MOSFET, said capacitor being adapted to hold said first MOSFET and said second MOSFET in an open or closed state; and
a resistor connected to said gate of said first MOSFET and said input of said control line.

8. The refreshable latching switch of claim 7 further comprising:
a zener diode connected in parallel with said capacitor, said zener diode being sufficient to regulate the voltage of said capacitor such that the gate to source voltage of said first MOSFET or the gate to source voltage of said second MOSFET is not exceeded.

9. A dual pole refreshable switch with low current drain comprising:
a first switchable signal line having an input and an output;
a second switchable signal line having an input and an output;
a control line having an input;
a first MOSFET and a second MOSFET wherein the source of said first MOSFET and the source of said second MOSFET are connected, and said input of said first switchable signal line is connected to the drain of said first MOSFET and said output of said first switchable signal line is connected to the drain of said second MOSFET, and the gate of said first MOSFET is connected to said control line and the gate of said second MOSFET is connected to said control line;
a first capacitor connected from said gate of said first MOSFET to said source of said first MOSFET, said capacitor being adapted to hold said first MOSFET and said second MOSFET in an open or closed state;
a first resistor connected to said gate of said first MOSFET and said input of said control line;
a third MOSFET and a fourth MOSFET wherein the source of said third MOSFET and the source of said fourth MOSFET are connected, and said input of said second switchable signal line is connected to the drain of said third MOSFET and said output of said second switchable signal line is connected to the drain of said fourth MOSFET, and the gate of said third MOSFET is connected to said control line and the gate of said third MOSFET is connected to said control line;
a second capacitor connected from said gate of said third MOSFET to said source of said third MOSFET, said capacitor being adapted to hold said third MOSFET and said fourth MOSFET in an open or closed state; and
a second resistor connected to said gate of said third MOSFET and said input of said control line.

10. The refreshable latching switch of claim 9 further comprising:
a first zener diode connected in parallel with said first capacitor, said zener diode being sufficient to regulate the voltage of said first capacitor such that the gate to source voltage of said first MOSFET or the gate to source voltage of said second MOSFET is not exceeded; and
a second zener diode connected in parallel with said second capacitor, said second zener diode being sufficient to regulate the voltage of said second capacitor such that the gate to source voltage of said third MOSFET or the gate to source voltage of said fourth MOSFET is not exceeded.
